(19) United States
(12) Patent Application Publication
(10) Pub. No.: US 2026/0340503 A1
(43) Pub. Date: Oct. 29, 2026

(54) INFORMATION PROCESSING APPARATUS

(71) Applicant: TOYOTA JIDOSHA KABUSHIKI KAISHA, Aichi-ken (JP)

(72) Inventors: Mustafa ERDOGAN, Tokyo-to (JP); Quan KONG, Tokyo-to (JP); Norimasa KOBORI, Tokyo-to (JP)

(21) Appl. No.: 19/650,334

(22) Filed: Apr. 17, 2026

(30) Foreign Application Priority Data
Apr. 25, 2025 (JP) 2025-073554

(51) Int. Cl. G06N 20/00

(52) U.S. Cl. CPC G06N 20/00

(57) ABSTRACT

An information processing apparatus monitors the training status when a machine learning model is being trained in a distributed manner across multiple apparatuses. The information processing apparatus includes a controller. The controller causes the multiple apparatuses to execute a machine learning process in a distributed manner, acquires the logs generated by the multiple apparatuses, and determines based on the logs whether an abnormal state is occurring in the machine learning process. When the abnormal state is occurring, the controller automatically stops the machine learning process, automatically changes the number of the multiple apparatuses that execute the machine learning process, and automatically causes a changed number of apparatuses to re-execute the machine learning process.

### CROSS-REFERENCE TO RELATED APPLICATION

This application claims priority to Japanese Patent Application No. 2025-073554 filed on Apr. 25, 2025, the entire contents of which are incorporated herein by reference.

### TECHNICAL FIELD

The present disclosure relates to an information processing apparatus.

### BACKGROUND

When training large language models (LLMs) or the like, it is efficient to use multiple apparatuses for distributed training. For example, Patent Literature (PTL) 1 discloses a scheduling method for distributed training tasks.

### CITATION LIST

### Patent Literature

PTL 1: JP 2024-535966 A

### SUMMARY

When machine learning processes stop at night, on weekends, or at other times for some reason, it takes time to resume the machine learning processes. This hinders machine learning from being performed efficiently. It is desirable to reduce such time loss and improve the efficiency of machine learning.

It would be helpful to reduce time loss during machine learning and to improve the efficiency of machine learning.

An information processing apparatus according to the present disclosure is configured to monitor the training status when a machine learning model is being trained in a distributed manner across multiple apparatuses, the information processing apparatus including a controller configured to:
cause the multiple apparatuses to execute a machine learning process in a distributed manner;
acquire the logs generated by the multiple apparatuses;
determine based on the logs whether an abnormal state is occurring in the machine learning process; and
when the abnormal state is occurring:
   automatically stop the machine learning process;
   automatically change the number of the multiple apparatuses that execute the machine learning process; and
   automatically cause a changed number of apparatuses to re-execute the machine learning process.

According to the present disclosure, it is possible to reduce time loss during machine learning and to improve the efficiency of machine learning.

### BRIEF DESCRIPTION OF THE DRAWINGS

In the accompanying drawings:

FIG. 1 is a diagram illustrating a configuration of an information processing system according to an embodiment of the present disclosure; and

FIG. 2 is a flowchart illustrating operations of the information processing system according to the embodiment of the present disclosure.

### DETAILED DESCRIPTION

An embodiment of the present disclosure will be described below with reference to the drawings.

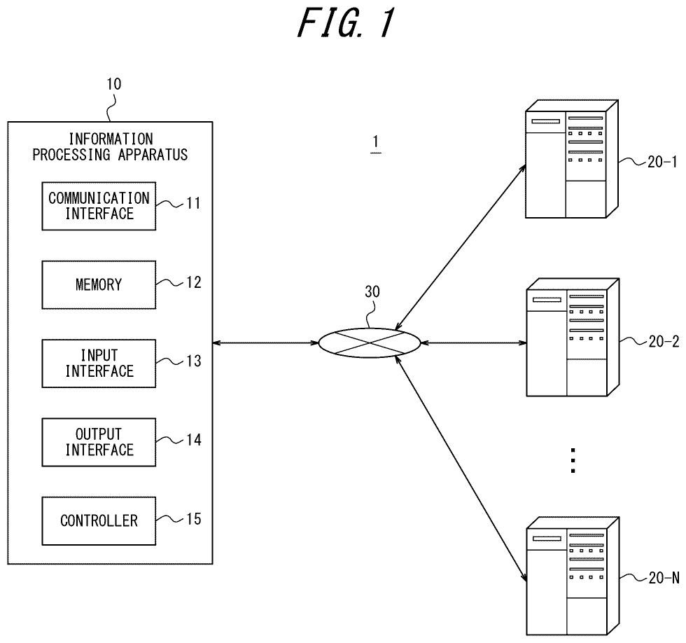

FIG. 1 is a diagram illustrating a configuration of an information processing system 1 according to the embodiment of the present disclosure. The configuration and outline of the information processing system 1 according to the embodiment of the present disclosure will be described with reference to FIG. 1.

The information processing system 1 includes an information processing apparatus 10 and apparatuses 20-1 to 20-N. The information processing apparatus 10 and apparatuses 20-1 to 20-N are communicably connected via a network 30. Hereafter, when there is no need to specifically distinguish between apparatuses 20-1 to 20-N, they may be referred to as “apparatus 20.” In FIG. 1, N apparatuses 20 are shown, but the number of apparatuses 20 may be any number of two or more.

The information processing apparatus 10 is a device that monitors the training status when a machine learning model is being trained in a distributed manner across multiple apparatuses 20. The information processing apparatus 10 may be a general-purpose electronic device such as a PC (Personal Computer) or a dedicated electronic device. The information processing apparatus 10 may be composed of multiple apparatuses.

Apparatus 20 is a device that can train a machine learning model. The information processing system 1 can efficiently train a machine learning model by using multiple apparatuses 20 to train the machine learning model in a distributed manner. Apparatus 20 may be a general-purpose electronic device such as a PC or a dedicated electronic device. Apparatus 20 is equipped with at least a GPU (Graphics Processing Unit) that executes machine learning. In FIG. 1, apparatus 20 is shown as an independent device, but apparatus 20 does not have to be an independent device as long as it is equipped with a GPU and functions as a computation node. In this case, for example, a server may have multiple computation nodes, and each computation node may train the machine learning model in parallel.

An outline of the present embodiment will be first described, and details thereof will be described later.

The information processing apparatus 10 executes a machine learning process for training the machine learning model in a distributed manner across multiple apparatuses 20. The machine learning model to be trained may be, for example, a large-scale language model. The information processing apparatus 10 acquires logs generated by apparatus 20 that is executing the machine learning process. Based on the acquired logs, the information processing apparatus 10 determines whether an abnormal state is occurring in the machine learning process. If an abnormal state is occurring, the information processing apparatus 10 automatically stops the machine learning process being executed by apparatus 20. Then, the information processing apparatus 10 automatically changes the number of apparatuses 20 executing the machine learning process and automatically re-executes the machine learning process with the changed number of apparatuses 20.

As shown in FIG. 1, the information processing apparatus 10 includes a communication interface 11, a memory 12, an input interface 13, an output interface 14, and a controller 15.

The communication interface 11 includes at least one external interface for communication. The interface for communication may be either a wired or wireless communication interface. In the case of wired communication, the interface for communication is, for example, a Local Area Network (LAN). In the case of wireless communication, the interface for communication is, for example, an interface compatible with mobile communication standards such as 5G, or an interface compatible with short-range wireless communication. The communication interface 11 receives data to be used in the operations of the information processing apparatus 10, and transmits data obtained by the operations of the information processing apparatus 10. The memory section 12 includes at least one semiconductor memory, magnetic memory, or optical memory. The memory section 12 functions, for example, as a main storage device or auxiliary storage device. The memory 12 stores data to be used in the operations of the information processing apparatus 10 and data obtained by the operations of the information processing apparatus 10. The input interface 13 includes at least one interface for input. The interface for input may be, for example, a physical key, a touch screen, an audio sensor that accepts audio input, or a camera that accepts gesture input. The input interface 13 accepts an operation for inputting data to be used for the operations of the information processing apparatus 10. The output interface 14 includes at least one interface for output. The interface for output is, for example, a display for outputting information in the form of images, or a speaker for outputting information in the form of audio. The output interface 14 outputs data obtained by the operations of the information processing apparatus 10. The control section 15 includes at least one processor. The processor is, for example, a general purpose processor such as a central processing unit (CPU), or a dedicated processor specialized for specific processing. The controller 15 executes processes related to the operations of the information processing apparatus 10 while controlling components of the information processing apparatus 10.

The functions of the information processing apparatus 10 are realized by executing a program according to the present embodiment by a processor corresponding to the control section 15. That is, the functions of the information processing apparatus 10 are realized by software. The program causes a computer to execute operations of the information processing apparatus 10, thereby causing the computer to function as the information processing apparatus 10. That is, the computer executes the operations of the information processing apparatus 10 in accordance with the program to thereby function as the information processing apparatus 10. In the present embodiment, the program can be recorded on a computer readable recording medium. The computer readable recording medium includes a non-transitory computer readable medium and is, for example, a magnetic recording apparatus or a semiconductor memory. The program is distributed, for example, by selling, transferring, or lending a portable recording medium such as a DVD on which the program is recorded. The program may also be distributed by storing the program in a storage of an external server and transmitting the program from the external server to another computer. The program may be provided as a program product. Some or all of the functions of the information processing apparatus 10 may be realized by a dedicated circuit corresponding to the control section 15. That is, some or all of the functions of the information processing apparatus 10 may be realized by hardware.

### Operations of Information Processing System

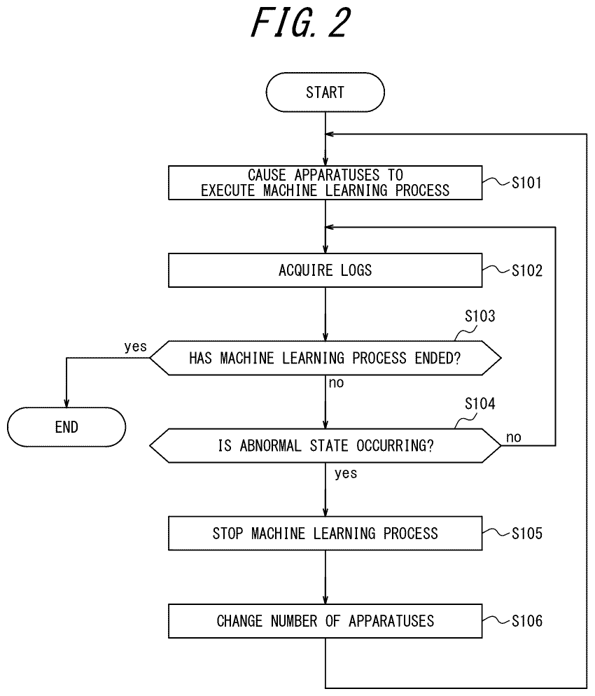

Operations of the information processing system 1 are described with reference to the flowchart in FIG. 2.
S101: The control section 15 of the information processing apparatus 10 executes a machine learning process to train a machine learning model in a distributed manner using multiple apparatuses 20. The control section 15 may execute the machine learning process on multiple apparatuses 20 by sending commands to the multiple apparatuses 20 via the communication interface 11.
S102: Device 20 executing the machine learning process generates logs indicating the status of the machine learning process. Device 20 sends the logs to information processing apparatus 10. Controller 15 acquires the logs generated by device 20 via communication interface 11. The logs contain at least one piece of information including GPU usage, number of steps, loss, epoch number, learning rate, batch size, and model parameters.
S103: Controller 15 determines whether the machine learning process executed by device 20 has ended or not. If the machine learning process has ended (Yes in S103), controller 15 terminates the processing for training the machine learning model. If the machine learning process has not ended (No in S103), controller 15 proceeds to S104.
S104: Controller 15 determines whether an abnormal state is occurring in the machine learning process executed by device 20 based on the logs acquired from device 20.

Controller 15 may determine whether an abnormal state is occurring based on various criteria from the information contained in the logs. For example, controller 15 may determine that an abnormal state is occurring if GPU usage is 0%. For example, controller 15 may determine that an abnormal state is occurring if GPU usage is above a threshold. In this case, the threshold may be a pre-set value. For example, controller 15 may determine that an abnormal state is occurring if the increase in the number of steps does not meet predetermined conditions. Typically, the number of steps increases after a nearly constant amount of time has passed. For example, if the difference in time taken to increase the number of steps by one is greater than a predetermined difference compared to the time taken for the last increase, controller 15 may determine that an abnormal state is occurring. Controller 15 may determine that an abnormal state is occurring if, for example, the time taken to increase the number of steps by one is more than 10% longer or shorter than the time taken for the last increase. Additionally, controller 15 may automatically change the threshold for determining an abnormal state according to the batch size. For example, if the batch size is larger than a predetermined size, controller 15 may increase the difference in time taken between steps for determining an abnormal state compared to when the batch size is below the predetermined size. Additionally, controller 15 may determine whether an abnormal state is occurring based on model parameters. For example, if the fluctuation of model parameters is larger than a predetermined size, controller 15 may increase the difference in time taken between steps for determining an abnormal state compared to when the fluctuation is below the predetermined size. If the variation of the model parameters is large, the processing time is likely to be longer.

If an abnormal state is occurring (Yes in S104), the controller 15 proceeds to S105. If an abnormal state is not occurring (No in S104), the controller 15 returns to S102.
S105: The controller 15 automatically stops the machine learning process.
S106: The controller 15 automatically changes the number of multiple apparatuses 20 executing the machine learning process. For example, the controller 15 may change the number of apparatuses 20 executing the machine learning process to the maximum available number at that time. At this time, the controller 15 may determine, for example, that the apparatuses 20 that can execute the machine learning process are the available apparatuses 20. Alternatively, the controller 15 may increase the number of apparatuses 20 executing the machine learning process by a predetermined number.

When the controller 15 changes the number of apparatuses 20 executing the machine learning process, it returns to S101 and automatically re-executes the machine learning process with the changed number of apparatuses 20. When automatically re-executing the machine learning process, the controller 15 may resume the machine learning process from the checkpoint at which it was stopped.

As described above, in the information processing apparatus 10 according to the present embodiment, the controller 15 causes the machine learning process to be executed in a distributed manner by multiple apparatuses 20, acquires the logs generated by the multiple apparatuses 20, and determines whether an abnormal state is occurring in the machine learning process based on the acquired logs. Then, if an abnormal state is occurring, the controller 15 automatically stops the machine learning process, automatically changes the number of multiple apparatuses 20 executing the machine learning process, and automatically re-executes the machine learning process with the changed number of apparatuses. Thus, if an abnormal state is occurring, the controller 15 automatically stops the machine learning process, automatically changes the number of multiple apparatuses 20 executing the machine learning process, and automatically re-executes the machine learning process. As a result, the information processing apparatus 10 according to the present embodiment can prevent the machine learning process from remaining in a state where an abnormal state has occurred, thereby reducing time loss when performing machine learning and enabling efficient machine learning. Moreover, by changing the number of multiple apparatuses 20 executing the machine learning process and re-executing the machine learning process, the information processing apparatus 10 according to the present embodiment can reduce the possibility of an abnormal state occurring in the re-executed machine learning process.

The present disclosure is not limited to the embodiment described above. For example, a plurality of blocks described in the block diagram may be integrated, or a block may be divided. Instead of executing a plurality of steps described in the flowchart in chronological order in accordance with the description, the plurality of steps may be executed in parallel or in a different order according to the processing capability of the apparatus that executes each step, or as required. Other modifications can be made without departing from the spirit of the present disclosure.

For example, some of the processing operations executed in the information processing apparatus 10 in the above embodiment may be executed in the apparatus 20. Also, some of the processing operations executed in the apparatus 20 in the above embodiment may be executed in the information processing apparatus 10.

1. An information processing apparatus configured to monitor a training status when a machine learning model is being trained in a distributed manner across multiple apparatuses, the information processing apparatus comprising a controller configured to:
cause the multiple apparatuses to execute a machine learning process in a distributed manner;
acquire logs generated by the multiple apparatuses;
determine based on the logs whether an abnormal state is occurring in the machine learning process; and
when the abnormal state is occurring:
automatically stop the machine learning process;
automatically change a number of the multiple apparatuses that execute the machine learning process; and
automatically cause a changed number of apparatuses to re-execute the machine learning process.

2. The information processing apparatus according to claim 1, wherein the controller is configured to change the number of the multiple apparatuses to a maximum available number.

3. The information processing apparatus according to claim 1, wherein the logs each include information on GPU usage, a number of steps, loss, an epoch number, a training rate, a batch size, and/or a model parameter.

4. The information processing apparatus according to claim 3, wherein the controller is configured to determine that the abnormal state is occurring when the GPU usage is 0% or when the GPU usage is greater than or equal to a threshold.

5. The information processing apparatus according to claim 3, wherein the controller is configured to determine that the abnormal state is occurring when an increase in the number of steps does not meet a predetermined condition.
